(19) United States
(12) Patent Application Publication
(10) Pub. No.: US 2003/0151525 A1
(43) Pub. Date: Aug. 14, 2003

(54) Illuminated road safety sign

(76) Inventor: John L. Scardina JR., Berwyn, IL (US)

Correspondence Address: Richard C. Litman, LITMAN LAW OFFICES, LTD., P.O. Box 15035, Arlington, VA, 22215, US

(21) Appl. No.: 10/361,595

(22) Filed: Feb. 11, 2003

Related U.S. Application Data
(60) Provisional application No. 60/355,827, filed on Feb. 13, 2002.

(51) Int. Cl. G08G 1/095

(52) U.S. Cl. 340/908

(57) ABSTRACT

An illuminated road safety sign for communicating a message or warning, and including two light transmitting plates, each plate displays a message. The plates are spaced by a surrounding, reflective sidewall. A sidewall mounting connector made of a moldable rubber, plastic, or other material sits on a flashlight. The elasticity of the connector allows it to deform around the flashlight or other light source and hold the sign in place. The flashlight provides light to illuminate the plate and message contained by reflecting off of a reflective material or coating on the interior of the sidewall.

### CROSS-REFERENCE TO RELATED APPLICATION

This application claims the benefit of U.S. Provisional Patent Application Serial No. 60/355,827, filed Feb. 13, 2002.

### BACKGROUND OF THE INVENTION

1. Field of the Invention

The present invention relates generally to illuminated road safety signs. More specifically, the invention is an illuminated road safety sign that utilizes either a flashlight as the source of light and a handle or a vehicle's cigarette lighter device.

2. Description of the Related Art

Numerous inventions have been devised to warn or to communicate with motorists and pedestrians. Some of the more significant advances in the art have centered around the development of illuminated signal signs, particularly those that are hand-held. The related art describes illuminated safety signs that have a lighting apparatus that requires an integrated part of the design, thereby requiring a specific light, as well as limiting the utility of the light.

U.S. Pat. No. 4,042,919, issued on Aug. 16, 1977, to Richard L. Patty, describes a hand-held illuminated sign that includes a strobe light with an on/off switch. This sign includes a plurality of parts that are assembled using numerous screws. The flashlight is mechanically fastened to the sign from the inside, and the light is not intended for other uses.

U.S. Pat. No. 3,821,860, issued on Jul. 2, 1974, to Richard L. Patty, shows a portable hand-held internally illuminated sign in which the body is formed in two halves that are joined together with glue or threaded fasteners. The light source is a flashlight that is fastened with threaded fasteners. While this design allows for the removal of the flashlight, to do so requires partial disassembly of the sign.

U.S. Pat. No. 5,440,464, issued on Aug. 8, 1995, to Richard R. Nowlin et al., discusses an externally illuminated hand-held highway sign, having a removable light shroud. The light shroud has two sets of bulbs, each set illuminates one side of the sign. The light shroud includes an external power source. The bulbs could be easily broken.

U.S. Pat. No. 5,694,110, issued on Dec. 2, 1997, to Tim Clifford, shows an illuminated signal devise having an external power source. The light mechanism is an integral part of the design and is not intended for other uses. The sign can be hand-held in combination with a power supply belt, or mounted using a bracket and external power source. The external power supply makes the sign cumbersome to use and difficult to share between multiple operators.

U.S. Pat. No. 5,755,051, issued on May 26, 1998, to Edward J. Zumbuhl, describes a warning light and sign apparatus, having two sides. The first side has the message “STOP”, and the second side has the message “SLOW”. Each side has a flashing light that is appropriately red for “STOP” or yellow for “SLOW”. The flashing lights are intended to draw the attention of oncoming motorists, but not illuminate the face of the sign.

U.S. Pat. No. 5,276,424, issued on Jan. 4, 1994, to John J. Hegemann, describes an attention getting sign having at least two lights. To improve the attention getting capability of the sign, only a single light is illuminated at any one time. Each of the two flat surfaces of the sign has a light emitting area at the top and bottom. This invention provides flashing lights to warn motorist. However, the lights are not intended to illuminate the message on the sign for improved visibility.

None of the above inventions and patents, taken either singly or in combination, is seen to describe the instant invention as claimed.

### SUMMARY OF THE INVENTION

The present invention provides an illuminated road safety sign for communicating a message or warning to motorists or pedestrians. The invention has two light transmitting plates, and each plate displays a message. The two messages could be the same or different. The two plates are spaced opposite one another in a fixed position by a sidewall. The sidewall has a light reflective material or coating applied to the interior, and an opening. A connector is adjoined to the opening in the sidewall. The connector is made of a moldable rubber, plastic, or other material on which a flashlight or other light source can be attached. The elasticity of the material will allow the connector to deform around the flashlight or other light source and hold it in place. The flashlight or other light source can be easily detached from the connector with a twist and pull.

The flashlight or other light source provides the light to illuminate the plate and message contained there on by reflecting off of the light reflective material or coating on the interior of the wall. The flashlight provides a handle that can be used by the operator to hold the sign or it can be fitted into a base.

Accordingly, it is a principal object of the invention to provide a new illuminated road safety sign that communicates two messages and uses an ordinary flashlight or other light source as the source of illumination.

It is another object of the invention to provide a lightweight, durable illuminated road safety sign that can be hand-held or adjoined to a base or bracket to communicate the illuminated messages.

It is a further object of the invention to improve the safety of persons that are directing traffic, stranded, or otherwise need to safely communicate with or direct surrounding persons.

Still another object of the invention is to provide a new illuminated road safety sign that may be easily manufactured and marketed.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view showing the invention is use.

FIG. 2 is an elevational view of the front of a preferred embodiment of the invention.

FIG. 3 is an elevational view of the rear of a preferred embodiment of the invention.

FIG. 4 is a view similar to FIG. 2, but showing the interior of the invention.

FIG. 5 is a side view of the invention as shown in FIG.4.

FIG. 6 is an exploded elevational view of the invention in pre-assembly with a flashlight.

FIG. 7 is a view similar to FIG. 6, but showing the invention in assembly with a flashlight.

FIG. 8 is an exploded elevational view of another embodiment of the invention.

FIG. 9 is an exploded elevational view of a further embodiment of the invention.

Similar reference characters denote corresponding features consistently throughout the attached drawings.

### DETAILED DESCRIPTION OF THE PREFERRED EMBODIMENTS

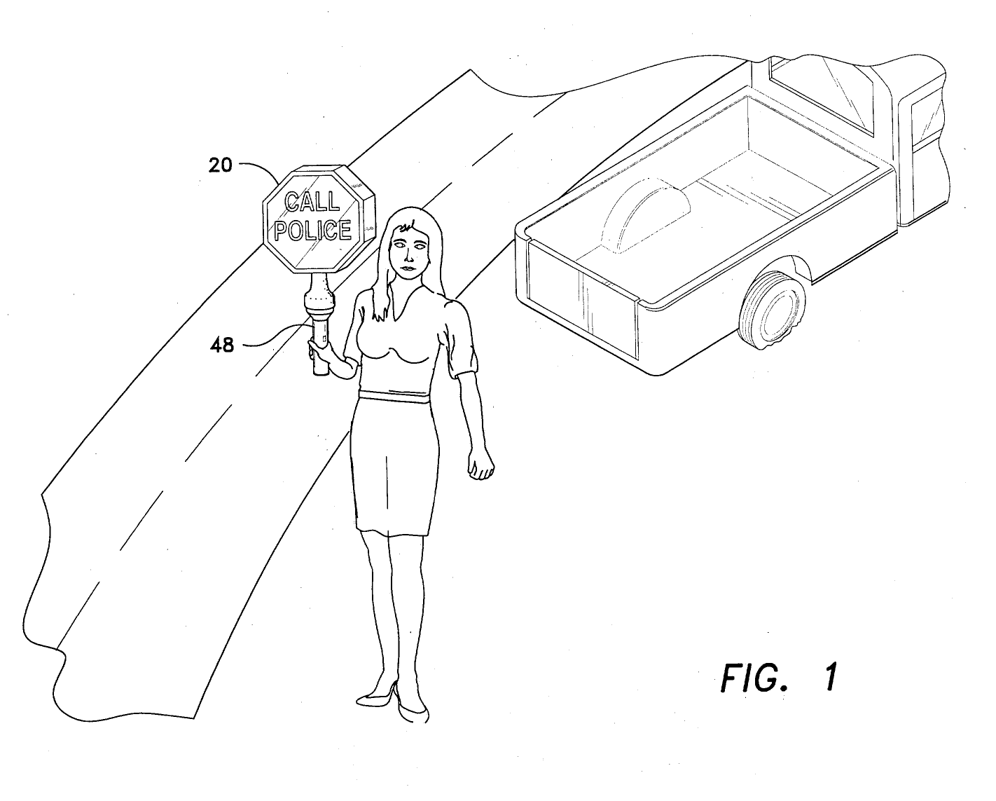

The present invention provides an illuminated road safety sign. The preferred embodiment of the invention is depicted in FIGS. 1-7, and is generally referenced by numeral 20.

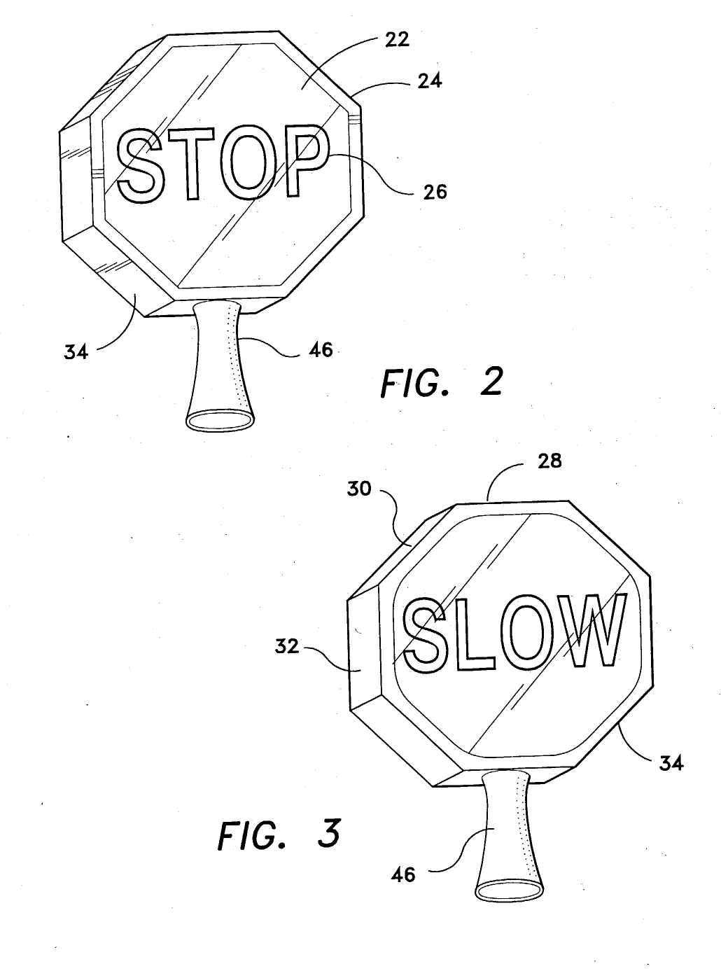

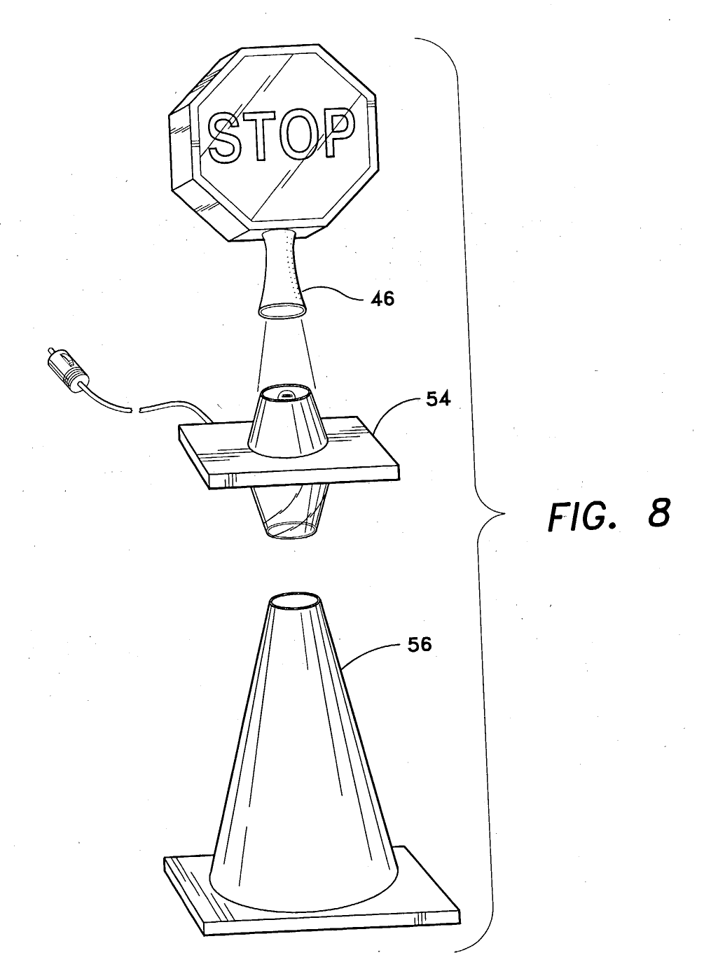

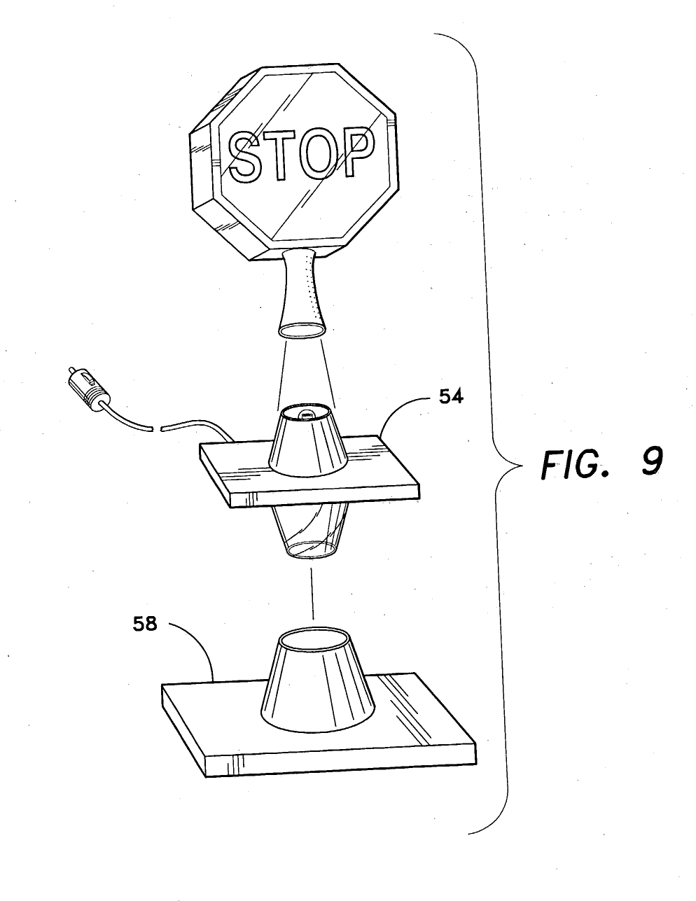

As diagrammatically illustrated in FIG. 1, an environmental view of the illuminated road safety sign 20 in combination with a flashlight 48 is seen in a hand-held operative position. The flashlight 48 has a handle 50 and a lens assembly 52. In its operative position, the illuminated road safety sign 20 can be held using the handle 50 of the flashlight 48. Alternatively, the illuminated road safety sign 20 and flashlight 48 assembly could be inserted into a cone 56 (FIG. 8)or base 58 (FIG. 9) such that it can be positioned to communicate the messages 26, 32 (FIGS. 2 and 3) to approaching persons. In the hand-held position the operator can rotate the sign to display one or both of the two messages 26, 32. The message 26, 32 can be either the same or different, and can be a directional wording, a symbol, or other phrase. The messages 26, 32 are visible to persons approaching the illuminated road safety sign 20 from opposite directions.

In the preferred embodiment of the invention, the first plate 22 and the second plate 28 are positioned opposite one another and held in a fixed position by a sidewall 34. The plates 22, 28 are made of a light transmitting or translucent material. The plates 22, 28 are shown to have a hexagonal shape; however, the plates can be made in any shape that best displays the messages 26, 32 to be communicated.

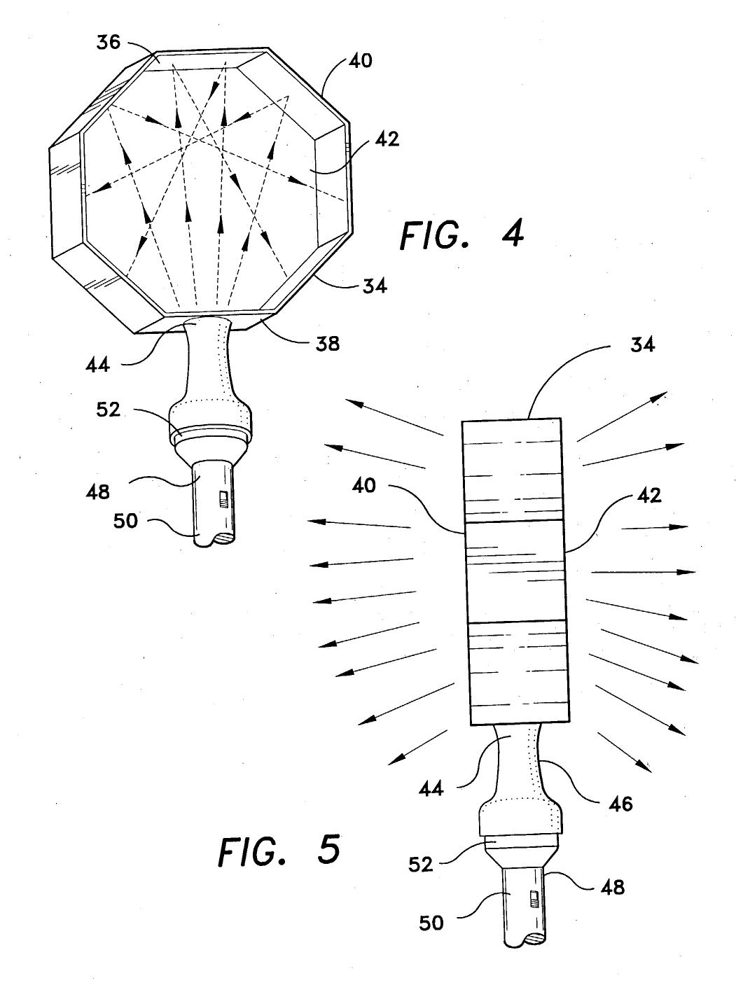

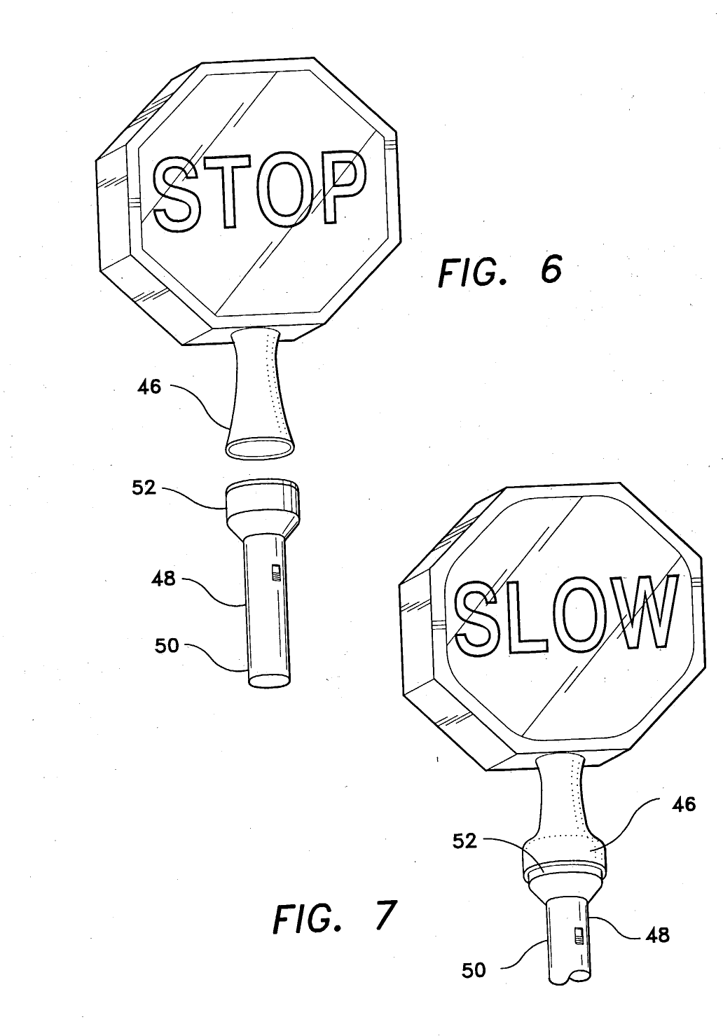

The first plate 22 has an outer circumference 24 that is adjoined to a first side 40 of the sidewall 34 (FIGS. 4 and 5). The second plate 28 (FIG. 3) has an outer circumference 30 that is adjoined to a second side 42 of the sidewall 34. The sidewall 34 has an interior 36, and exterior 38, and an opening 44. A connector 46 is adjoined around the opening 44 on the exterior 38 of the side wall 34 (FIGS. 2 and 3). The illuminated road safety sign 20 and the flashlight 48 are adjoined by inserting the lens assembly 52 into the connector 46. The connector 46 is a flexible and elastic material such that the connector 46 will become molded around the lens assembly 52 when pressure is applied. The connector 46 and lens assembly 52 can easily be separated by twisting them apart; see FIGS. 6 and 7.

The interior 36 of the side wall 34 is a composed. of a light reflective material or has a light reflective material or coating adhered thereto. The light reflective properties of the interior 36 of the side wall 34 reflect the light provided by the flashlight 48 such that the plates 22, 28 are illuminated; see FIGS. 4 and 5.

In the preferred embodiment of the invention, the illuminated road safety sign 20 is made of a rubber material or a durable plastic. The material is flexible, lightweight and durable. The material handles cold and heat, and withstands a fair amount of abuse. The connector 46 has elastic capabilities so that it can be deformed around either the lens assembly 52 of a flashlight 48, or an alternative light source 54.

The material used for the plates 22, 28 will be translucent to allow the sign to be illuminated by the flashlight 48. The illuminated road safety sign 20 can be constructed from multiple pieces that are glued or fastened together, or molded as one piece. The illuminated road safety sign and the message 26, 32 can have different colors to maximize visibility. The colors of the illuminated road safety sign 20 and message 26, 32 are selected to maximize the visibility and recognition of the message 26, 32 being communicated. For example, a color of an illuminated road safety sign 20 that is used to communicate “STOP” could be red and the message 26, 32 could be white or clear. The colors may be integral to the material or applied to the material, either internally or externally.

In another embodiment of the invention, the illuminated road safety sign 20 is used in combination with an alternate light source 54, and a cone 56, as seen in FIG. 8. Wherein the illuminated road safety sign 20 is forcibly fit onto the alternate light source 54, and the alternate light source 54 is forcibly fit onto the cone 56. The alternate light source can be powered by a battery, through a car cigarette lighter or other source. The sign 20 is illuminated by the light from the alternate light source 54. The cone 54 supports the illuminated road safety sign 20 such that it can be positioned, to communicate the messages 26, 32 to approaching persons. The alternate light source 54 and cone 56 could be an integrated device.

In a further embodiment of the invention, the illuminated road safety sign 20 is used in combination with an alternate light source 54, and a base 58. See FIG. 9. Wherein the illuminated road safety sign 20 is forcibly fit onto the alternate light source 54, and the alternate light source 54 is forcibly fit onto the base 58. The illuminated road safety sign 20 is illuminated by the light from the alternate light source 54. The base 58 supports the illuminated road safety sign 20 such that it can be positioned to communicate the messages 26, 32 to approaching persons. The alternate light source 54 and base 58 could be an integrated device.

It is to be understood that the present invention is not limited to the embodiments described above, but encompasses any and all embodiments within the scope of the following claims.

I claim:

1. An illuminated road safety sign comprising:
a light transmitting first plate having an outer circumference and directional wording;
a light transmitting second plate having an outer circumference and directional wording;
a side wall, having an interior, an exterior, a first side, a second side, and an opening between the interior and exterior;
said first plate's outer circumference adjoined to said wall first side, and said second plate's outer circumference adjoined to said wall second side, thereby positioning said first plate opposite said second plate; and
said wall opening on the exterior having a connecting means adjoined thereon, whereby a flashlight or other light source can be attached thereto.

2. The illuminated road safety sign according to claim 1, wherein said first plate direction wording is selected from the group consisting of: “STOP”, “SLOW”, “GO”, ACCIDENT SCENE”, “POLICE”, “SEND HELP”, “CALL POLICE”’ and “DO NOT ENTER”.

3. The illuminated road safety sign according to claim 1, wherein said second plate direction wording is selected from the group consisting of: “STOP”, “SLOW”, “GO”, ACCIDENT SCENE”, “POLICE”, “SEND HELP”, “CALL POLICE”’ and “DO NOT ENTER”.

4. The illuminated road safety sign according to claim 1, wherein said wall interior includes a light reflecting material.

5. The illuminated road safety sign according to claim 1, wherein said wall interior includes a light reflective coating.

6. The illuminated road safety sign according to claim 1, wherein said illuminated road safety sign further comprises, in combination:
a light source;
a base;
said illuminated road safety sign being adjoined to said light source; and
said light source mounted on said base.
